(19) United States
(12) Patent Application Publication
(10) Pub. No.: US 2008/0012727 A1
(43) Pub. Date: Jan. 17, 2008

(54) Mirror having a field emission information display

(76) Inventor: Kuei Wen Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/485,995

(22) Filed: Jul. 14, 2006

(51) Int. Cl. G08G 1/01

(52) U.S. Cl. 340/933

(57) ABSTRACT

A mirror having a field emission information display includes a semitransmitting reflective mirror body for a rear vision mirror located on the outside of a car, a field emission unit located in the semitransmitting reflective mirror body, and a control system located in the semitransmitting reflective mirror body. The field emission unit comprises an anode part, a cathode part corresponding to the anode part, and a spacer located between the anode part and the cathode part to form a specified gap, and a gate pole located on the cathode part. The control system is electrically connected with the field emission unit for controlling the field emission unit to display the information. Thereby, the field emission unit is controlled by the control system to generate an information image area on a surface of the semitransmitting reflective mirror body, and the gate pole increases the brightness of the information image area.

### BACKGROUND OF THE INVENTION

1. Field of the Invention

The present invention relates to a mirror having a field emission information display. In particular, this invention relates to a mirror having a field emission information display that combines a field emission unit having a three-pole structure and a semitransmitting reflective mirror. The mirror having a field emission information display generates an information display having a high brightness, and the generated information image is detailed and colorful.

2. Description of the Related Art

As technology has been rapidly developing, pedestrian safety has become an increasingly key factor in car design. Alarms are now commonly installed on rear vision mirrors located on the outside of cars for alerting pedestrians or other cars that the car is moving in their direction. The alarms are installed on the outer frame of the reflective mirrors or in the reflective mirrors. The lighting element can be conventional lamps, CCFLs, or LEDs.

Recently, new flat lighting elements have been developed, such as field emission displays. Field emission displays (FEDs) make cathode-ray tubes (CRTs) flatter and thinner. The displaying principle of FEDs is similar to that of CRTs. Both emit electrons from the cathode. The electrons pass through a vacuum and are accelerated by the anode to excite fluorescence to light. The fluorescence used for CRTs is the same as that for FETs. The main difference is the generating method of the electrons. Common CRTs generate electrons by heating the cathode. The FET absorbs the electrons from the cathode via an electric field. Therefore, FEDs are more suitable as a display used for car displaying devices.

Reference is made to FIG. 1, which shows a schematic diagram of an FED of the prior art. The FED includes an anode 100a and a cathode 200a. There is a spacer 400a located between the anode 100a and the cathode 200a. The spacer 400a forms a vacuum area between the anode 100a and the cathode 200a, and is used as a support for the anode 100a and the cathode 200a. The anode 100a includes an anode substrate 100a, an anode conducting layer 11a, and a fluorescence powder layer 12a. The cathode 200a includes a cathode substrate 20a, a cathode conducting layer 21a, and an electron emission layer 22a, a gate pole layer 300a, and an insulating layer 500a. The spacer 400a is located between the anode 100a and the gate pole layer 300a of the cathode 200a to form a vacuum area. Next, an external electrical field is provided between the gate pole layer 300a and the cathode 200a to make the electron emission layer 22a of the cathode 200a generate electrons. The anode 100a provides a high voltage to accelerate the electrons. Therefore, the electrons are emitted to the fluorescence powder layer 12a of the anode substrate 10a so that the fluorescence powder layer 12a is excited to light.

### SUMMARY OF THE INVENTION

One particular aspect of the present invention is to provide a mirror having a field emission information display. The present invention combines a three-pole structure of a field emission unit with a semitransmitting reflective mirror so that the brightness of information generated on the semitransmitting reflective mirror is greater than 1000 cd/m². Therefore the information image is detailed and colorful. When the car misses a turn or needs to alert the driver of a situation, the mirror having a field emission information display is used as a reflective mirror. When the car makes a turn or needs to alert the driver of a situation, a lighting pattern is displayed on the mirror having a field emission information display to inform oncoming cars.

The mirror having a field emission information display of the present invention includes a semitransmitting reflective mirror body which acts as a rear vision mirror located on the outside of a car, a field emission unit located in the semitransmitting reflective mirror body, and a control system located in the semitransmitting reflective mirror body. The field emission unit includes an anode part, a cathode part corresponding to the anode part, and a spacer located between the anode part and the cathode part to form a specified gap. The anode part has an anode substrate, an anode conducting layer located on the anode substrate, and a fluorescent layer located above the anode conducting layer. The cathode part has a cathode substrate, a cathode conducting layer located on the cathode substrate, an emission layer located on the cathode conducting layer, a gate pole located on the cathode substrate, and a rib located between the cathode substrate and the gate pole. The control system is electrically connected with the field emission unit for controlling the field emission unit to display information. Thereby, the field emission unit is controlled by the control system to generate an information image area on the surface of the semitransmitting reflective mirror body. The gate pole increases the brightness of the information image area. Furthermore, the present invention further includes a light-guiding board located on one side of the anode part. The light-guiding board is used for increasing the brightness of the filed emission display. The color of the light-guiding board is white. The light-guiding board is made of MgO or is an aluminum film that reflects light so that the reflecting brightness is increased.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the mirror having a field emission information display of the prior art;

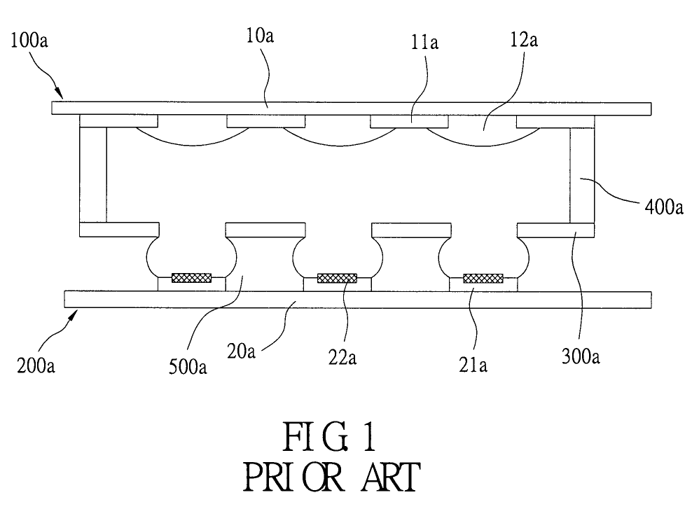

FIG. 2 is a schematic diagram of the field emission unit of the mirror having a field emission information display of the present invention;

FIG. 3 is a cross-sectional view of the mirror having a field emission information display of the present invention;

FIG. 4 is a block diagram of the mirror having a field emission information display of the present invention;

FIG. 5 is a block diagram of the driving circuit module of the mirror having a field emission information display of the present invention;

FIG. 6 is a block diagram of the feedback circuit module of the mirror having a field emission information display of the present invention; and

FIG. 7 is a perspective view of the display function of the mirror having a field emission information display of the present invention.

### DETAILED DESCRIPTION OF THE PREFERRED EMBODIMENTS

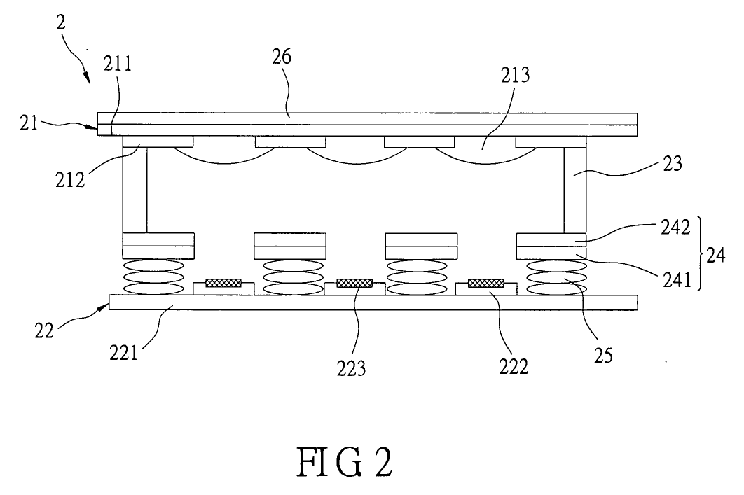

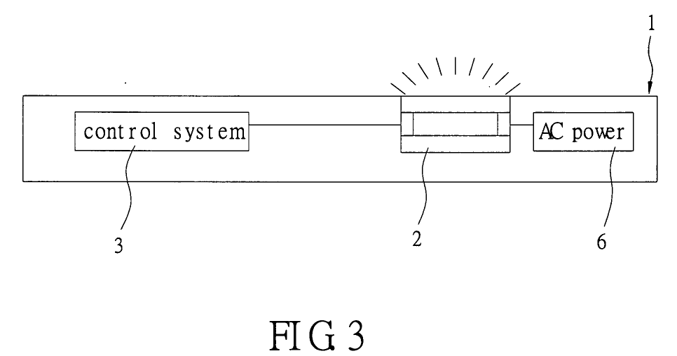

Reference is made to FIG. 2, which shows a schematic diagram of the field emission unit of the mirror having a field emission information display of the present invention. The field emission unit 2 includes an anode part 21, a cathode part 22 corresponding to the anode part 21, and a spacer 23 located between the anode part 21 and the cathode part 22 to form a specified gap. The anode part 21 has an anode substrate 211, an anode conducting layer 212 located on the anode substrate 211, and a fluorescent layer 213 located above the anode conducting layer 212. The cathode part 22 has a cathode substrate 221, a cathode conducting layer 222 located on the cathode substrate 221, an emission layer 223 located on the cathode conducting layer 222, a gate pole 24 located on the cathode substrate 221, and a rib 25 located between the cathode substrate 221 and the gate pole 24. The emission layer 223 is made of carbon nanotube powder and is used as an electron emission source. The emission layer 223 is a carbon nanotube layer formed by coating or screen printing by electrophoresis. The carbon nanotube layer is a carbon nanotube that has been improved and has a high electron emission rate. The fluorescent layer 213 is composed of a phosphor that emits red light, yellow light, or green light. The gate pole 24 is a screen-masked metal structure having multiple holes. The gate pole 24 has a gate pole screen mask 241 connected with the rib 25, and a gate pole light-guiding layer 242 connected with the gate pole screen mask 241. The gate pole light-guiding layer 242 is formed by evaporating a metal material on the gate pole screen mask 241 of the anode part 21. The gate pole light-guiding layer 242 is made of MgO. The gate pole screen mask 241 absorbs the electrons from the electron emission source of the cathode part 22. The electrons pass through the multiple holes of the gate pole 24 to emit to the fluorescent layer 213 of the anode part 21. The gate pole light-guiding layer 242 enhances the brightness of the information image. The anode part 21 further has a reflecting layer 26 located on one side of the anode part 21 that is opposite to the anode conducting layer 212. The reflecting layer is formed by evaporating a metal material (aluminum) on the anode part 21, or is combined with the anode part 21 via a firm-pasting method. The reflecting layer reflects the electron beam emitting to the anode part 21 to the surface of the semitransmitting reflective mirror body 1 (referring to FIG. 3) so as to display an information image.

Reference is made to FIG. 3, which shows a cross-sectional view of the mirror having a field emission information display of the present invention. The mirror having a field emission information display of the present invention has a field emission unit 2, a control system 3, and an AC power 6 installed in a semitransmitting reflective mirror body 1. The field emission unit 2 is electrically connected with the control system 3, and the AC power 6, and generates an information image area 8 on the surface of the semitransmitting reflective mirror body 1.

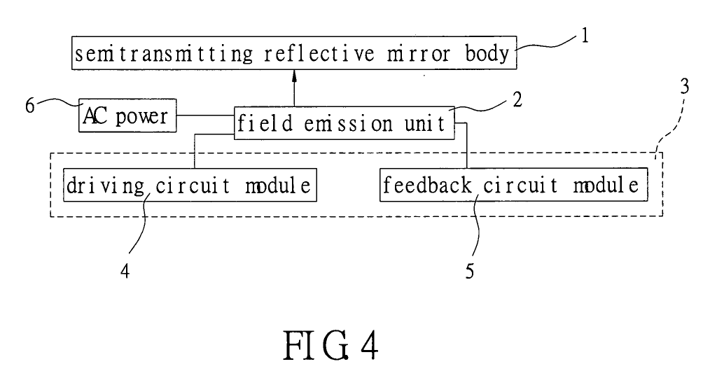

Reference is made to FIG. 4, which shows a block diagram of the mirror having a field emission information display of the present invention. The mirror having a field emission information display of the present invention includes a semitransmitting reflective mirror body 1 for a rear vision mirror located outside of a car, a field emission unit 2, a control system 3, and an AC power 6. The control system 3 is electrically connected with the field emission unit 2, and controls the field emission unit 2 to generate an information image. The control system 3 includes a driving circuit module 4, and a feedback circuit module 5. The driving circuit module 4 controls the field emission unit 2 to display the information image. The feedback circuit module 5 makes the brightness of the field emission unit 2 uniform.

The AC power 6 is electrically connected with the field emission unit 2. The AC power 6 cooperates with the driving circuit module 4 to make the field emission unit 2 dynamically display the information image.

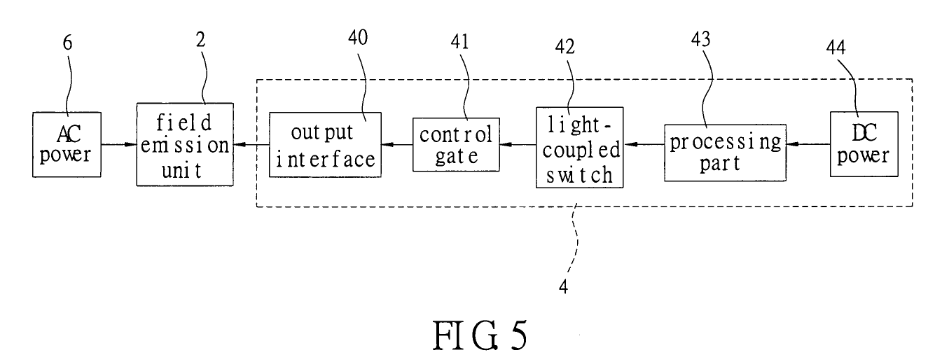

Reference is made to FIGS. 2 and 5. FIG. 5 shows a block diagram of the driving circuit module of the mirror having a field emission information display of the present invention. The driving circuit module 4 includes an output interface 40 connected with the cathode part 22 of the field emission unit 2, at least one control gate 41 connected with the output interface 40, at least one light-coupled switch 42 connected with the control gate 41, and a processing part 43 connected with the light-coupled switch 42. The processing part 43 is connected with a DC power 44, and the DC power 44 provides the power required by the processing part 43. The processing part 43 process digital data or program data stored in the inner data register. When the data is processed, the processing part 43 outputs a control signal and transmits the control signal to the light-coupled switch 42. The control signal drives the light-coupled switch 42, and controls the control gate 41 connected with the light-coupled switch 42 to turn on. The light-coupled switch 42 separates and protects the processing part 43. The control gate 41 is connected with the cathode part 22 of the field emission unit 2 via the output interface 40 to control the cathode part 22 to be grounded or floated. The control gate 41 is composed of at least one logic switch. The logic switch can be a CMOS logic switch, a NMOS logic switch, or a TTL logic switch etc.

The gate pole screen mask 241 is connected with the AC power 6. When the cathode part 22 is grounded, the emission layer 223 of the cathode part 22 generates electrons, and the electrons are accelerated by the AC power 6 located between the gate pole screen mask 241 and the cathode part 22 to excite the fluorescent layer 213 located on the anode part 21.

The rib 25 located between the anode part 21 and the cathode part 22 separates the electrons generated between the emission layers to prevent the electrons from disturbing each other.

When the control gate 41 controls the cathode part 22 to be floated, no driving electric field is built between the gate pole screen mask 241 and the cathode part 22. The electrons cannot be generated from the cathode part 22. Therefore, the field emission unit 2 cannot display any information images.

Because the anode part 21 of the field emission unit 2 is connected with the AC power 6, the field emission unit 2 will light and display the information image when the AC power 6 is a positive electric field and the cathode part 22 of the field emission unit 2 is grounded. Alternatively, when the cathode part 22 of the field emission unit 2 is floated, the field emission unit 2 cannot display any information images. Therefore, by connecting the gate pole screen mask 241 with a high frequency AC power 6 and controlling the cathode part 22 to be grounded or floated, the field emission unit 2 can dynamically display information images.

When the AC power is in a negative electric filed, the electric charge accumulated at the anode part 21 is released. Therefore, the heat generated during the continuous lighting process is reduced so that the usage life of the mirror having a field emission information display is extended. The AC power 6 is a high frequency and high voltage AC power.

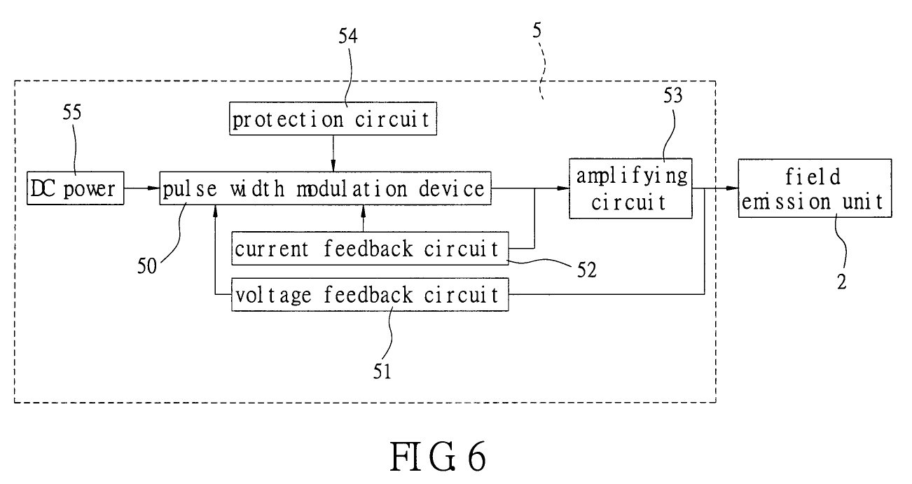

Reference is made to FIG. 6, which shows a block diagram of the feedback circuit module of the mirror having a field emission information display of the present invention. The feedback circuit module 5 includes a pulse width modulation device 50 connected with a DC power 55 that converts the DC power 55 into AC power, a voltage feedback circuit 51 connected between the pulse width modulation device 50 and the field emission unit 2, a current feedback circuit 52 connected between the pulse width modulation device 50 and the field emission unit 2, an amplifying circuit 53 connected between the pulse width modulation device 50 and the field emission unit 2, and a protection circuit 54 connected with the pulse width modulation device 50. The voltage feedback circuit 51 is used for feeding back a voltage signal. The current feedback circuit 52 is used for feeding back a current signal. The pulse width modulation device 50 detects the voltage signal and the current signal to adjust the level of the AC power. The pulse width modulation device 50 is controlled by an integrated circuit. The protection circuit 54 protects the feedback circuit so as to prevent the circuit from being burned down.

The front stage of the amplifying circuit 53 is connected with the pulse width modulation device 50 to form the current feedback circuit 52 for feeding back the AC current and being a stable closed loop. After the AC current is fed back to the pulse width modulation device 50, the pulse width modulation device 50 detects the signal level of the feedback AC current. When the level of the feedback signal is distorted, the current density of the field emission unit 2 is affected. At this moment, the pulse width modulation device 50 compensates for the level of the feedback signal to make the current density of the field emission unit 2 uniform. Therefore, the brightness of the information image displayed on the field emission unit 2 is uniform and assured.

The back stage of the amplifying circuit 53 is connected with the pulse width modulation device 50 to form the voltage feedback circuit 51 for feeding back the AC voltage and being a stable closed loop. The pulse width modulation device 50 compensates for the feedback AC voltage so that the brightness of the information images displayed on the field emission unit 2 is adequate, and the brightness of the information image is uniform.

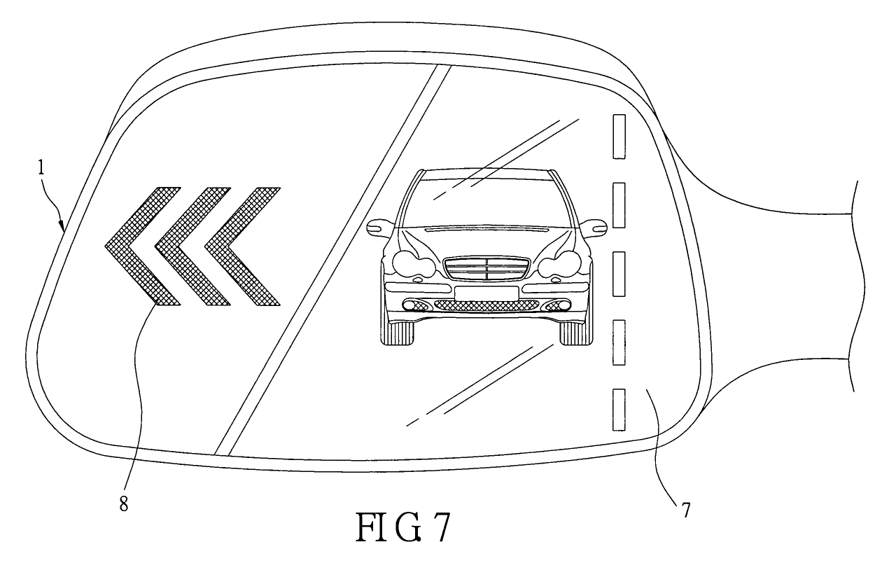

Reference is made to FIG. 7, which shows a perspective view of the display function of the mirror having a field emission information display of the present invention. When the driver misses a turn or needs to be made aware of a situation, the driver can see any oncoming cars via the mirrored surface 7 of the semitransmitting reflective mirror body 1. When a driver makes a turn or needs to alert other drivers of a situation, the driver can alert oncoming cars via the information image displayed on the information image area 8 of the semitransmitting reflective mirror body 1. The alerting effect is achieved.

The mirror having a field emission information display of the present invention integrates the anode part 21 and the cathode part 22 of the field emission unit 2 with the semitransmitting reflective mirror body 1, and is controlled by the control system 3. The mirror having a field emission information display of the present invention has the following characteristics:

1. The mirror having a field emission information display provides the reflective mirror and displays information images.

2. The brightness of the displayed information image is greater than 1000 cd/m².

3. The information image is detailed and colorful.

4. If the driver misses a turn or needs to alert other drivers of a situation, the mirror having a field emission information display is used as a reflective mirror. displays the speed of the car, and can be used as a night light. When the driver makes a turn or needs to alert other drivers of a situation, the driver can alert oncoming cars via the information image.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A mirror having a field emission information display, comprising:
a semitransmitting reflective mirror body for a rear vision mirror located on an outside of a car;
a field emission unit located in the semitransmitting reflective mirror body, wherein the field emission unit comprises an anode part, a cathode part corresponding to the anode part, and a spacer located between the anode part and the cathode part to form a specified gap, the anode part has an anode substrate, an anode conducting layer located on the anode substrate, and a fluorescent layer located above the anode conducting layer, the cathode part has a cathode substrate, a cathode conducting layer located on the cathode substrate, an emission layer located on the cathode conducting layer, a gate pole located on the cathode substrate, and a rib located between the cathode substrate and the gate pole; and
a control system located in the semitransmitting reflective mirror body; wherein the control system is electrically connected with the field emission unit for controlling the field emission unit to display the information;
thereby, the field emission unit is controlled by the control system to generate an information image area on a surface of the semitransmitting reflective mirror body, and the gate pole increases the brightness of the information image area.

2. The mirror having a field emission information display as claimed in claim 1, wherein the emission layer is made of carbon nanotube powder.

3. The mirror having a field emission information display as claimed in claim 1, wherein the emission layer is a carbon nanotube layer formed by coating or screen printing by electrophoresis.

4. The mirror having a field emission information display as claimed in claim 1, wherein the gate pole is a screen-masked structure having multiple holes.

5. The mirror having a field emission information display as claimed in claim 1, wherein the gate pole comprises a gate pole screen mask connected with the rib, and a gate pole light-guiding layer connected with the gate pole screen mask.

6. The mirror having a field emission information display as claimed in claim 5, wherein the gate pole light-guiding layer is formed by evaporating a metal material on the gate pole screen mask.

7. The mirror having a field emission information display as claimed in claim 6, wherein the metal material is aluminum.

8. The mirror having a field emission information display as claimed in claim 5, wherein the gate pole light-guiding layer is made of MgO.

9. The mirror having a field emission information display as claimed in claim 1, wherein the fluorescent layer is composed of a phosphor that emits red light, yellow light, or green light.

10. The mirror having a field emission information display as claimed in claim 2, wherein the carbon nanotube layer is a carbon nanotube that has been improved and has a high electron emission rate.

11. The mirror having a field emission information display as claimed in claim 5, wherein the gate pole screen mask is connected with an AC power for providing power required by the filed emission unit.

12. The mirror having a field emission information display as claimed in claim 11, wherein the AC is a high frequency and high voltage AC power.

13. The mirror having a field emission information display as claimed in claim 1, wherein the control system further has a driving circuit module, wherein the driving circuit module comprises an output interface connected with the cathode part, at least one control gate connected with the output interface, at least one light-coupled switch connected with the control gate, and a processing part connected with the light-coupled switch, and the processing part is connected with a DC power.

14. The mirror having a field emission information display as claimed in claim 13, wherein the control gate is controlled by the light-coupled switch to control the cathode to be grounded or floated.

15. The mirror having a field emission information display as claimed in claim 13, wherein the control gate is composed of a logic switch.

16. The mirror having a field emission information display as claimed in claim 15, wherein the logic switch is a CMOS logic switch, a NMOS logic switch, or a TTL logic switch.

17. The mirror having a field emission information display as claimed in claim 13, wherein the processing part comprises a data register for storing digital information.

18. The mirror having a field emission information display as claimed in claim 1, wherein the control system further comprises a feedback circuit module, and the feedback circuit module comprises a pulse width modulation device connected with a DC power and that converts DC power into AC power, a voltage feedback circuit connected between the pulse width modulation device and the field emission unit, a current feedback circuit connected between the pulse width modulation device and the field emission unit, an amplifying circuit connected between the pulse width modulation device and the field emission unit, and a protection circuit connected with the pulse width modulation device, wherein the voltage feedback circuit is used for feeding back a voltage signal, the current feedback circuit is used for feeding back a current signal, and the pulse width modulation device detects the voltage signal and the current signal to adjust the level of the AC power.

19. The mirror having a field emission information display as claimed in claim 18, wherein the pulse width modulation device is controlled by an IC chip.

20. The mirror having a field emission information display as claimed in claim 18, wherein a front stage of the amplifying circuit is connected with the pulse width modulation device to form the current feedback circuit.

21. The mirror having a field emission information display as claimed in claim 18, wherein a back stage of the amplifying circuit is connected with the pulse width modulation device to form the voltage feedback circuit.

22. The mirror having a field emission information display as claimed in claim 18, wherein the voltage feedback circuit feeds back the level of the voltage signal to form a closed loop.

23. The mirror having a field emission information display as claimed in claim 18, wherein the current feedback circuit feeds back the level of the current signal to form a closed loop.
